(19) United States
(12) Patent Application Publication
(10) Pub. No.: US 2013/0092258 A1
(43) Pub. Date: Apr. 18, 2013

(54) FLOW RATE CONTROL DEVICE, AND DIAGNOSTIC DEVICE AND RECORDING MEDIUM RECORDED WITH DIAGNOSTIC PROGRAM USED FOR FLOW RATE CONTROL DEVICE

(71) Applicant: HORIBA STEC, CO., LTD., Kyoto-shi (JP)

(72) Inventors: Tadahiro Yasuda, Kyoto-shi (JP); Shigeyuki Hayashi, Kyoto-shi (JP); Akito Takahashi, Kyoto-shi (JP); Tetsuo Shimizu, Kyoto-shi (JP)

(73) Assignee: HORIBA STEC, CO., LTD., Kyoto-shi (JP)

(21) Appl. No.: 13/651,099

(22) Filed: Oct. 12, 2012

(30) Foreign Application Priority Data
Oct. 14, 2011 (JP) 2011-227400

(51) Int. Cl. G05D 7/06; G01F 1/34

(52) U.S. Cl. 137/487; 73/861.42

(57) ABSTRACT

In order to be able to diagnose an abnormality occurring in a flow rate control valve with high reliability, and for example, if an abnormality occurs in the flow rate control valve, quickly perform appropriate maintenance or the like, a first measured flow rate diagnostic part that, on the basis of a second measured flow rate value or a measured pressure value, diagnoses an abnormality of a first measured flow rate value, and a valve diagnostic part that, when the first measured flow rate diagnostic part diagnoses that the first measured flow rate value has no abnormality, diagnoses an abnormality of the flow rate control valve are provided.

### TECHNICAL FIELD

The present invention relates to a flow rate control device that has a configuration to diagnose abnormalities occurring due to clogging or the like, and a diagnostic device and a diagnostic program that are used for the flow rate control device.

### BACKGROUND ART

For example, in manufacturing or the like of semiconductor products, it is necessary to place wafers in a chamber of a CVD apparatus or the like and accurately supply process gases containing raw materials necessary for deposition at target flow rates.

To control a flow rate of each of such process gases, a mass flow controller provided in a flow channel connected to the chamber is used. In the mass flow controller, a flow channel is formed inside, and a block body is attached with various types of flow rate control devices integrated into one package, including: a flow rate measuring mechanism that measures a flow rate of fluid flowing through the flow channel, such as a thermal type flow rate sensor; a flow rate control valve; and a valve control part that controls an opening level of the flow rate control valve so as to decrease an error between a measured flow rate value measured by the flow rate measuring mechanism and a target flow rate value.

Meanwhile, as such a mass flow controller is used, a product produced from the process gas may clog a flow rate measuring sensor, valve, or the like, and prevent accurate flow rate control. For this reason, there is a mass flow controller that is, in order to be able to detect abnormalities, and to appropriately perform maintenance or the like before an unacceptable flow rate control error occurs due to clogging or the like, provided with a diagnostic part for self-diagnosing whether or not a value of a flow rate controlled by the mass flow controller is correct.

For example, a mass flow controller disclosed in Patent literature 1 is one that is further provided with a pressure sensor that measures a pressure on an upstream side of a flow rate control valve, and also provided with a diagnostic part that refers to a reference voltage value stored in memory, which was applied to the flow rate control valve under conditions equivalent to a measured flow rate value currently measured by the flow rate measuring mechanism in a state where flow rate control by the mass flow controller is correctly performed, and a supply pressure value is measured by the pressure sensor; compares the reference voltage value to an applied voltage value currently applied to the flow rate control value; and if these values are different, self-diagnoses that the flow rate control by the mass flow controller is not normally performed.

However, although such a diagnostic part may be able to diagnose that the flow rate control is not correctly performed due to some sort of abnormality occurring somewhere in the mass flow controller, it is difficult to diagnose in detail which one of the components, such as the flow rate measuring mechanism and flow rate control valve constituting the mass flow controller, gives rise to abnormality such as clogging.

More specifically, even if the reference voltage value and the applied voltage value are different, there exist two possible causes, i.e., the case where an error occurs in the measured flow rate value because clogging occurs in the flow rate measuring mechanism, so that a measured value is generated that is different from the corresponding reference voltage value stored in memory, and therefore the abnormality occurs, and the case where clogging occurs in the flow rate control valve, and therefore the applied voltage value currently applied to the flow rate control valve is different from the reference voltage value. However, it is not clear how to determine which cause is responsible for the difference.

In other words, even in the case of attempting to apply the diagnostic part as disclosed in Patent literature 1 to diagnose abnormalities such as clogging in the flow rate control valve, whether or not the measured flow rate value serving as a basis for the reference voltage value serving as a criterion is correct is not guaranteed, and therefore even if a diagnostic result of the flow rate control valve is produced, whether or not the diagnostic result is really correct cannot be relied on.

### CITATION LIST

### Patent Literature

Patent literature 1: JPA 2009-157578

### SUMMARY OF THE INVENTION

### Technical Problem

The present invention is made in consideration of the above-described problem, and intended to provide: a flow rate control device that can diagnose an abnormality occurring in a flow rate control valve with high reliability, and for example, if the abnormality occurs in the flow rate control valve, immediately perform appropriate maintenance or the like; and a diagnostic device and diagnostic program that are used for the flow rate control device.

### Solution to Problem

That is, a flow rate control device of the present invention is provided with: a first flow rate measuring mechanism configured to measure a flow rate of fluid flowing through a flow channel; a flow rate control valve that is provided in the flow channel; a valve control part configured to control an opening degree of the flow rate control valve so as to reduce an error between a target flow rate value and a first measured flow rate value measured by the first flow rate measuring mechanism; a fluid measuring mechanism configured to measure a flow rate or a pressure of the fluid flowing through the flow channel; a first measured flow rate diagnostic part configured to diagnose an abnormality of the first measured flow rate value, based on a second measured flow rate value or a measured pressure value measured by the fluid measuring mechanism; and a valve diagnostic part configured to diagnose an abnormality of the flow rate control valve, based on the opening level control parameter that is inputted to the flow rate control valve by the valve control part, a supply pressure value that is a pressure measured on an upstream side of the flow rate control valve, and at least one of the first measured flow rate value, the second measured flow rate value, and the measured pressure value, in the case where the first measured flow rate diagnostic part diagnoses that the first measured flow rate value has no abnormality.

Also, a diagnostic device of the present invention is a diagnostic device for use in a flow rate control device provided with: a first flow rate measuring mechanism configured to measure a flow rate of fluid flowing through a flow channel; a flow rate control valve provided on the flow channel; and a valve control part configured to control an opening degree of the flow rate control valve so as to reduce an error between a target flow rate value and a first measured flow rate value measured by the first flow rate measuring mechanism, the diagnostic device comprising: a fluid measuring mechanism configured to measure a flow rate or a pressure of the fluid flowing through the flow channel; a first measured flow rate diagnostic part configured to diagnose an abnormality of the first measured flow rate value, based on a second measured flow rate value or a measured pressure value measured by the fluid measuring mechanism; and a valve diagnostic part configured to diagnose an abnormality of the flow rate control valve, based on the opening level control parameter that is inputted to the flow rate control valve by the valve control part, a supply pressure value that is a pressure measured on an upstream side of the flow rate control valve, and at least one of the first measured flow rate value, the second measured flow rate value, and the measured pressure value, in the case where the first measured flow rate diagnostic part diagnoses that the first measured flow rate value has no abnormality.

Here, the “opening level control parameter” refers to an input control parameter such as an applied voltage value, applied current value, or pulse width of a PWM signal that is inputted from the valve control part to the flow rate control valve. Also, the opening level of the flow rate control valve is changed to an opening level depending on each value of the opening level control parameter.

Accordingly, the present invention is configured such that, first, on the basis of the second measured flow rate value or the measured pressure value, the first measured flow rate diagnostic part judges whether or not an abnormality occurs in the first measured flow rate value used to control the opening level of the flow rate control valve, and as a result, after it is guaranteed that the abnormality does not occur in the first measured flow rate value, the valve diagnostic part diagnoses abnormality of the flow rate control valve on the basis of the first measured flow rate value, supply pressure value, and applied voltage value, and can therefore reliably judge only whether or not the abnormality occurs in the flow rate control valve. In other words, whether the first flow rate measuring mechanism or the flow rate control valve gives rise to an abnormality such as clogging can be diagnosed in distinction from each other.

Also, it is guaranteed that the first measured flow rate value has no abnormality, and therefore a result of the diagnosis of the flow rate control valve by the valve diagnostic part can also be brought to a reliable result.

In order to, during the diagnosis of the first measured flow rate value by the first measured flow rate diagnostic part, prevent the occurrence of disturbance or unexpected variation, and to improve reliability of a result of the diagnosis of the first measured flow rate value, it is only necessary that the present invention is further provided with a stable state judging part configured to judge whether or not a state of the fluid flowing through the flow channel is in a stable state, based on the first measured flow rate value, or the second measured flow rate value measured by the fluid measuring mechanism, or the measured pressure value, wherein the first measured flow rate diagnostic part is configured to diagnose the abnormality of the first measured flow rate value in the case where the state of the fluid is the stable state.

In order to make a flow rate measurement principle different between the first flow rate measuring mechanism and the fluid measuring mechanism, to thereby prevent an abnormality from rendering the abnormality judging ineffective due to the simultaneous occurrence of abnormalities, it is only necessary that the first flow rate measuring mechanism is a thermal type flow rate sensor, and the fluid measuring mechanism is a pressure type flow rate sensor.

Specific configurations for simply diagnosing the abnormality of the flow rate control valve include a configuration in which the valve diagnostic part is configured to diagnose the abnormality of the flow rate control valve relative to a reference opening level control parameter that is the opening level control parameter having been inputted to the flow rate control valve by the valve control part under conditions equivalent to the first measured flow rate value and the supply pressure value that are currently measured with the opening level control parameter currently inputted to the flow rate control valve by the valve control part in the case where the flow rate control valve is normal.

In order to be able to also guarantee correctness of the second measured flow rate value that is a premise for diagnosing whether or not the first measured flow rate value measured by the first measured flow rate mechanism has abnormality, and further in order to enhance reliability of a result of the diagnosis of the flow rate control valve by the valve diagnostic part, it is only necessary that the present invention is further provided with a second measured flow rate diagnostic part configured to diagnose an abnormality of the second measured flow rate value measured by the fluid measuring mechanism.

In order to be able to diagnose the abnormality of the flow rate control valve only with information obtained by a single body of the flow rate control device, it is only necessary that the present invention is further provided with a supply pressure measuring sensor provided on the upstream side of the flow rate control valve, and outputs the supply pressure value.

Preferred embodiments for enabling the above-described diagnostic function for the flow rate control valve to be later included by installing a program from a recording medium into an existing flow rate control device include a diagnostic program for use in a flow rate control device provided with: a first flow rate measuring mechanism configured to measure a flow rate of fluid flowing through a flow channel; a flow rate control valve provided on the flow channel; a valve control part configured to control an opening degree of the flow rate control valve so as to reduce an error between a target flow rate value and a first measured flow rate value measured by the first flow rate measuring mechanism; a fluid measuring mechanism configured to measure a flow rate or a pressure of the fluid flowing through the flow channel, the diagnostic program comprising: a first measured flow rate diagnostic part configured to diagnose an abnormality of the first measured flow rate value, based on a second measured flow rate value or a measured pressure value measured by the fluid measuring mechanism; and a valve diagnostic part configured to diagnose an abnormality of the flow rate control valve, based on the opening level control parameter that is inputted to the flow rate control valve by the valve control part, a supply pressure value that is a pressure measured on an upstream side of the flow rate control valve, and at least one of the first measured flow rate value, the second measured flow rate value, and the measured pressure value, in the case where the first measured flow rate diagnostic part diagnoses that the first measured flow rate value has no abnormality.

### Advantageous Effects of the Invention

As described, the flow rate control device of the present invention, the diagnostic device used for the flow rate control device, and the recording medium recorded with the diagnostic program are configured to, first, on the basis of the second measured flow rate value or the measured pressure value, judge whether or not an abnormality occurs in the first measured flow rate value used for the opening level control of the flow rate control valve, and after it is guaranteed that the abnormality does not occur, diagnose an abnormality of the flow rate control valve. The flow rate control device can therefore diagnose the abnormality of the flow rate control valve with high reliability.

### BRIEF DESCRIPTION OF THE DRAWINGS

FIG. 1 is a schematic diagram illustrating details of a mass flow controller and a diagnostic device in a first embodiment;

FIG. 2 is a schematic graph for describing operation of a stable state judging part in the first embodiment;

FIG. 3 is a schematic diagram illustrating an example of data structure stored in a valve applied voltage storage part in the first embodiment;

FIG. 4 is a flowchart illustrating operation at the time of diagnosis in the first embodiment;

FIG. 5 is a detailed schematic diagram illustrating a mass flow controller and a diagnostic device according to a second embodiment of the present invention; and

FIG. 6 is a schematic graph illustrating a diagnostic method by a pressure type flow rate diagnostic part in the second embodiment.

### DESCRIPTION OF REFERENCE CHARACTERS

100: Mass flow controller (flow rate control device)
200: Diagnostic device
1: Thermal type flow rate sensor (first flow rate measuring mechanism)
2: Flow rate control valve
21: Valve control part
3: Pressure type flow rate sensor (fluid measuring mechanism)
4: Stable state judging part
5: Thermal type flow rate diagnostic part (first measured flow rate diagnostic part)
7: Valve diagnostic part
8: Pressure type flow rate diagnostic part (second measured flow rate diagnostic part)

### DESCRIPTION OF THE EMBODIMENTS

A first embodiment of the present invention is described with reference to the drawings.

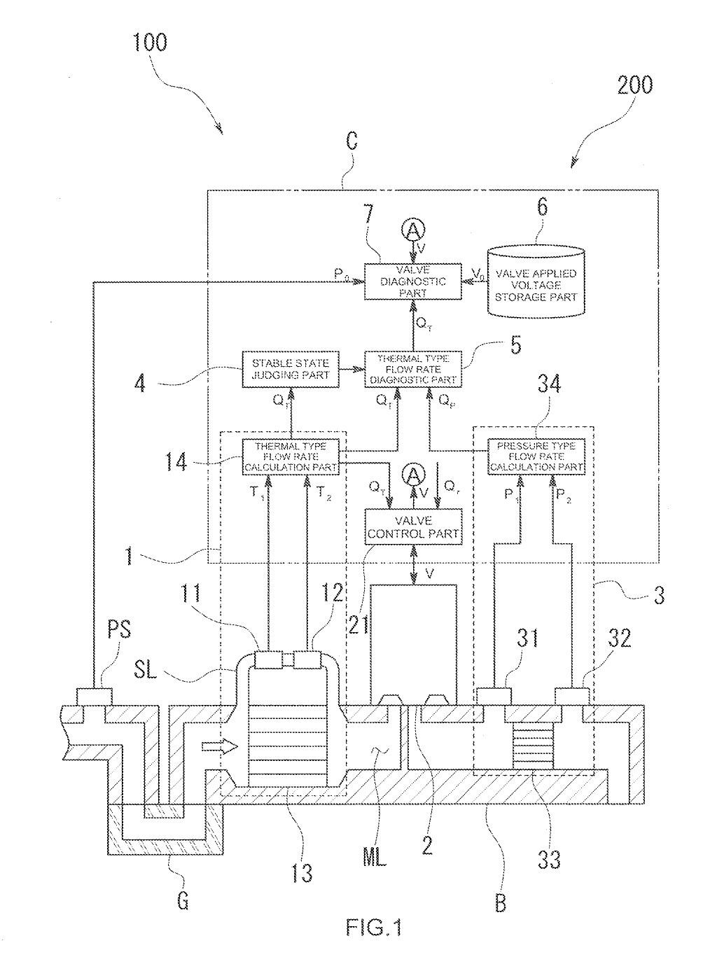

A flow rate control device of the first embodiment is a mass flow controller 100 that is used in semiconductor manufacturing or the like to supply process gas containing a raw material necessary for deposition into a chamber of a CVD apparatus or the like at a predetermined supply flow rate. The mass flow controller 100 is, as illustrated in a schematic diagram of FIG. 1, one in which a flow channel ML is formed by forming a through channel inside a block body B of a substantially rectangular parallelepiped shape, and packaged by attaching devices for fluid control and various devices constituting a diagnostic device 200 on an upper surface of the block body B.

More specifically, the mass flow controller 100 is one in which in the flow channel ML formed inside the block body B, a thermal type flow rate sensor 1, a flow rate control valve 2, and a pressure type flow rate sensor 3 are provided sequentially from an upstream side, and calculation part C that performs various types of calculations for controlling and diagnosing respective devices is further provided. The mass flow controller 100 supplies the process gas into a chamber at a desired flow rate by controlling an opening level of the flow rate control valve 2 so as to decrease an error between a first measured flow rate value Q_{T} measured by the thermal type flow rate sensor 1 and a target flow rate value Qᵣ.

The respective parts are described with reference to FIG. 1. First, a hardware configuration is mainly described.

The block body B is one that is, as illustrated in FIG. 1, opened on a lower surface, and provided with a fluid introduction port for introducing the fluid into the internal flow channel ML and a fluid lead-out port for leading out the fluid of which a flow rate is controlled, and on an upper surface thereof, the thermal type flow rate sensor 1, the flow rate control valve 2, and the pressure type flow rate sensor 3 are attached, and also attachment holes for making communicative connections to the flow channel ML are formed.

The thermal type flow rate sensor 1 is one that corresponds to a first flow rate measuring mechanism in the claims, and measures a flow rate of the fluid flowing through the flow channel ML inside the block body B. The thermal type flow rate sensor 1 is one that is provided with: a laminar flow element 13 that is provided in the flow channel ML; a sensor flow channel SL that is a substantially inverted U-shaped metallic narrow tube that is branched from the flow channel ML on an upstream side of the laminar flow element 13 and joins the flow channel ML on a downstream side of the laminar flow element 13; a first temperature sensor 11 and a second temperature sensor 12 that are respectively provided on upstream and downstream sides on an outer side of the metallic narrow tube forming the sensor flow channel SL; and a thermal type flow rate calculation part 14 that, on the basis of a difference between temperatures respectively measured by the first temperature sensor 11 and the second temperature sensor 12, converts the temperature difference to the flow rate of the fluid flowing through the flow channel ML. In addition, the thermal type flow rate calculation part 14 is configured with use of a calculation function (described below) of the calculation part C, and calculates the first measured flow rate value Q_{T} on the basis of following Expression 1:

Q_{T}=k_{T}(T₁−T₂), Expression 1

Herein, Q_{T} is the first measured flow rate value, k_{T} is a conversion factor from the temperature difference to the flow rate, T₁ is the upstream side temperature measured by the first temperature sensor 11, and T₂ is the downstream side temperature measured by the second temperature sensor 12.

The laminar flow element 13 is one that is intended to divide the flow of the fluid from the flow channel ML to the sensor flow channel SL at a predetermined ratio, and is formed by, for example, stacking thin plates formed with micro through grooves. That is, a length and depth of each of the through grooves are set so that when the fluid passes therethrough, the laminar flow element 13 brings the fluid into a laminar flow state. As described, the laminar flow element 13 has a microstructure, and therefore a product from the process gas passing through laminar flow element 13 may attach to the microstructure, for example, the through grooves, and cause clogging. Further, the sensor flow channel SL is formed of the metallic narrow tube, and therefore clogging may also occur there as well. If the clogging occurs in the laminar flow element 13 or the sensor flow channel SL, the flow dividing ratio is changed, so that the temperature difference measured by the first and second temperature sensors 11 and 12 does not reflect an actual flow rate, and therefore an abnormality occurs in the first measured flow rate value Q_{T} measured by the thermal type flow rate sensor 1.

The flow rate control valve 2 is, for example, a piezo valve adjusted to have an opening level depending on an applied voltage value applied by a valve control part 21 (described below). The flow rate control valve 2 may also give rise to clogging due to the attachment of a product of a component contained in the process gas. If the clogging occurs in the flow rate control valve 2, even in the case where the applied voltage from the valve control part is the same, the opening level is adjusted to a level smaller than an intended level, and therefore a flow rate of the fluid actually flowing takes a smaller value than during normal operation (e.g., when there is no abnormality). Accordingly, the error between the first measured flow rate value Q_{T} measured by the thermal type flow rate sensor 1 and the target flow rate value Qᵣ is not decreased, and therefore the applied voltage value V is changed so as to further increase the opening level of the flow rate control valve 2.

The pressure type flow rate sensor 3 is one that corresponds to a fluid measuring mechanism in the claims, and can also be considered as a second flow rate measuring mechanism relative to the first flow rate measuring mechanism. Also, the pressure type flow rate sensor 3 is one that measures a flow rate of the fluid flowing through the flow channel ML inside the block body B on a downstream side of the flow rate control valve 2. The pressure type flow rate sensor 3 is configured to include: a fluid resistor 33 that is provided in the flow channel ML, such as an orifice; a first pressure sensor 31 that is provided on an upstream side of the fluid resistor 33; a second pressure sensor 32 that is provided on a downstream side of the fluid resistor 33; and a pressure type flow rate calculation part 34 that, on the basis of pressures measured by the first pressure sensor 31 and the second pressure sensor 32, calculates the flow rate of the fluid flowing through the flow channel ML as a second measured flow rate value Q_{P}. In addition, the pressure type flow rate calculation part 34 is configured with use of a calculation function (described below) of the calculation part C, and calculates the second measured flow rate value Q_{P} on the basis of following Expression 2:

Q_{P}=k_{P}(P₁²−P₂²) Expression 2

Herein, Q_{P} is the second measured flow rate value, k_{P} is a conversion factor from the pressures to the flow rate which is judged depending on the fluid resistor 33, P₁ is the measured pressure value on the upstream side of the fluid resistor 33 measured by the first pressure sensor 31, and P₂ is the measured pressure value on the downstream side of the fluid resistor 33 measured by the second pressure sensor 32.

Next, a software configuration is mainly described.

The calculation part C is one having functions that are realized by a so-called computer, microcomputer, or the like, provided with a CPU, a memory, an input/output interface, A/D and D/A converters, and the like, and configured to execute a program stored in the memory to thereby fulfill the functions for at least the valve control part 21, a stable state judging part 4, a thermal type flow rate diagnostic part 5, a valve applied voltage storage part 6, and a valve diagnostic part 7. In addition, the diagnostic device 200 in the first embodiment is configured to include the pressure type flow rate sensor 3, the stable state judging part 4, the thermal type flow rate diagnostic part 5, the valve applied voltage storage part 6, and the valve diagnostic part 7.

The respective parts are described.

The valve control part 21 is one that, to decrease the error between the first measured flow rate value Q_{T} measured by the thermal type flow rate sensor 1 and the target flow rate value Qᵣ, inputs an opening level control parameter to the flow rate control valve to control the opening level of the flow rate control valve 2. In the present embodiment, as the opening level control parameter, the applied voltage value is selected. More specifically, when the first measured flow rate value Q_{T} is fed back, the error from the target flow rate value Qᵣ is calculated, and depending on the error, the voltage to be applied to the flow rate control valve 2 is changed. In addition, the target flow rate value Qᵣ may be set by preliminarily inputting an instruction value via a program, or may be successively input by external input. In the first embodiment, for the purpose of holding a constant target flow rate value Qᵣ value for a predetermined period of time, stepwise input values are inputted to the valve control part 21. For example, every time a process state is switched, the magnitude of step input is changed.

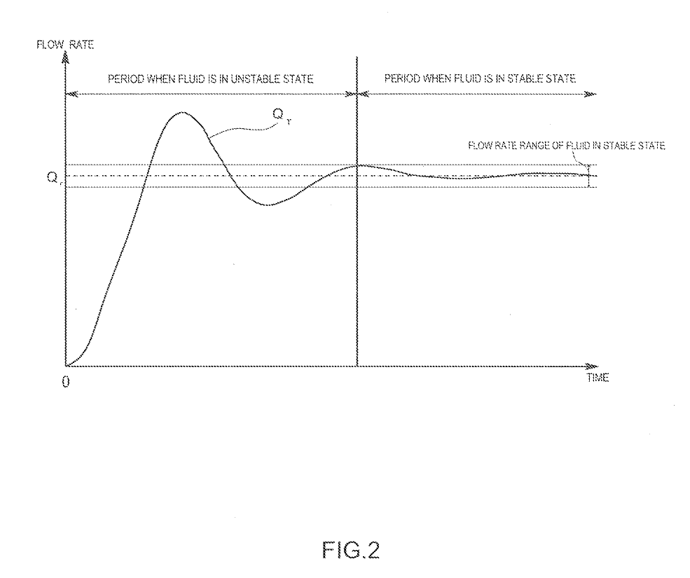

The stable state judging part 4 is one that, on the basis of the first measured flow rate value Q_{T}, judges whether or not a state of the fluid flowing through the flow channel ML is in a stable state. More specifically, the stable state judging part 4 is configured to judge that, as illustrated in a graph of FIG. 2, if a state where an absolute value of the error between the first measured flow rate value Q_{T} and the target flow rate value Qᵣ is equal to or less than a predetermined value continues for a predetermined period of time, the state of the fluid is the stable state. Furthermore, the words “the state of the fluid is the stable state” can also be reworded as a state where parameters related to a flow rate such as a flow rate, pressure, and the like of the fluid flowing through the flow channel ML do not largely vary as time passes, and are substantially constant. Further in other words, the state where the fluid is stable also refers to a state where the measured flow rate value Q_{T} and both or at least one of the measured pressure values are continuously, for a predetermined period of time, within predetermined value ranges. In addition, the above-described predetermined value and predetermined period of time may be preset before factory shipment of the device, or the like, or may be appropriately set by a user.

The thermal type flow rate diagnostic part 5 is one that corresponds to a first measured flow rate diagnostic part in the claims, and when the stable state judging part 4 judges that the state of the fluid is in the stable state, on the basis of the second measured flow rate value Q_{P}, diagnoses an abnormality of the first measured flow rate value Q_{T}. More specifically, if an absolute value of a difference between the first measured flow rate value Q_{T} and the second measured flow rate value Q_{P} is equal to or more than a predetermined value, the thermal type flow rate diagnostic part 5 diagnoses that the abnormality occurs in the first measured flow rate value Q_{T}, and if the absolute value is equal to or less than the predetermined value, the thermal type flow rate diagnostic part 5 diagnoses the first measured flow rate value Q_{T} as normal. That is, the thermal type flow rate diagnostic part 5 is configured to, if the difference between the first measured flow rate value Q_{T} and the second measured flow rate value Q_{P} is equal to or more than the predetermined value, diagnose that clogging occurs somewhere in the thermal type flow rate sensor 1, and the first measured flow rate value Q_{T} does not indicate a correct value.

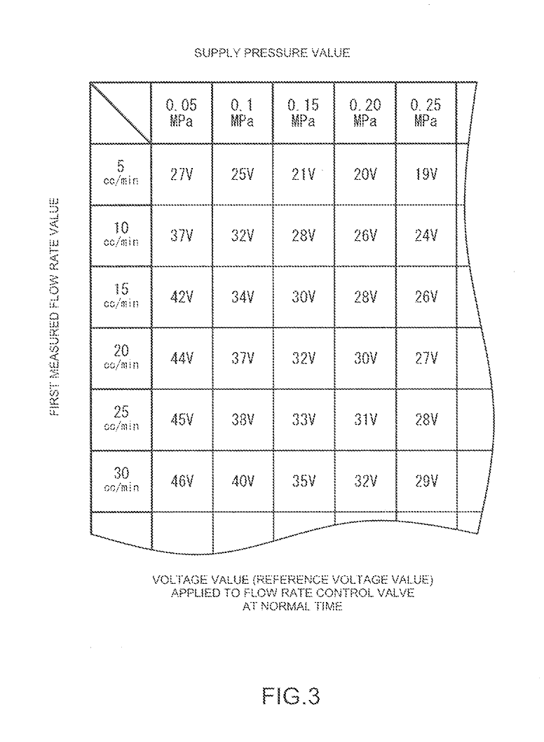

The valve applied voltage storage part 6 is one that, as illustrated in FIG. 3, stores a reference voltage value Vₒ (corresponding to a reference opening level control parameter in the claims), that is applied to the flow rate control valve 2 when the mass flow controller 100 normally operates. More specifically, the valve applied voltage storage part 6 stores the reference voltage value Vₒ corresponding to each of a plurality of combinations of a supply pressure value Pₒ of the fluid on an upstream side of the flow rate control valve 2 and the first measured flow rate value Q_{T} measured by the thermal type flow rate sensor 1.

The valve diagnostic part 7 is configured to, when the thermal type flow rate diagnostic part 5 diagnoses that the first measured flow rate value Q_{T} has no abnormality, on the basis of the first measured flow rate value Q_{T}, the applied voltage value V currently applied to the flow rate control valve 2 by the valve control part 21, and the supply pressure value Pₒ that is a pressure measured on the upstream side of the flow rate control valve 2, diagnose an abnormality of the flow rate control valve 2. In addition, the first embodiment is configured to obtain, as the supply pressure value Pₒ, a pressure measured by a supply pressure measuring sensor PS that is separately provided in a pipe connected through a fluid supply port and a gas panel G on the upstream side of the mass flow controller 100. More specifically, the valve diagnostic part 7 obtains, from the valve applied voltage storage part 6, the reference voltage value Vₒ that corresponds to the currently measured first measured flow rate value Q_{T} and the currently measured supply pressure value Pₒ and that is applied to the flow rate control valve 2 when no abnormality occurs in the mass flow controller 100. Furthermore, values of the reference voltage value Vₒ intermediate to those that are stored can be calculated and set by an interpolation calculation or the like using the stored reference voltage values Vₒ. The valve diagnostic part 7 is configured to calculate a difference between the reference voltage value Vo and the applied voltage value V currently applied to the flow rate control valve 2, to thereby make a comparison between the respective values, and if an absolute value of the difference is equal to or more than a predetermined value, diagnose that clogging occurs in the flow rate control valve 2, thereby giving rise to an abnormality. In addition, the predetermined value described here may also be a value appropriately set by a user depending on an allowable error, a particular usage situation, or the like.

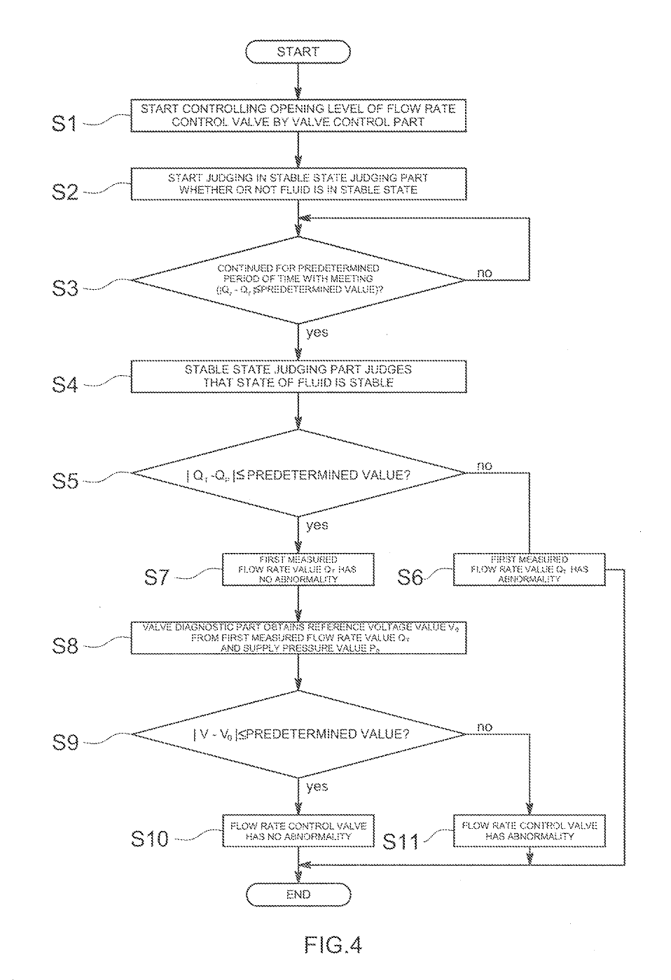

Operation at the time of diagnosing the flow rate control valve 2 in the mass flow controller 100 configured as described, is described with reference to a flowchart of FIG. 4.

When the flow rate control to decrease the error between the first measured flow rate value Q_{T} and the target flow rate value Qᵣ indicating a certain flow rate is started by the mass flow controller 100 (Step S1), the stable state judging part 4 starts judging whether or not the state of the fluid flowing through the flow channel is in the stable state (Step S2). If the state where the error between the first measured flow rate value Q_{T} outputted from the thermal type flow rate sensor 1 and the target flow rate value Qᵣ is equal to or less than the predetermined value continues for a predetermine period of time (Step S3), the stable state judging part 4 judges that the fluid is stable (Step S4).

After the stable state judging part 4 has judged that the fluid is stable, the thermal type flow rate diagnostic part 5 compares whether or not the absolute value of the difference between the first measured flow rate value Q_{T} and the second measured flow rate value Q_{P} is equal to or less than the predetermined value (Step S5), and if the difference is larger than the predetermined value, diagnoses that the first measured flow rate value Q_{T} outputted from the thermal type flow rate sensor 1 has an abnormality (Step S6). In this case, the valve diagnostic part 7 does not diagnose the flow rate control valve 2. Also, if the difference is less than the predetermined value, the thermal type flow rate diagnostic part 5 diagnoses that the first measured flow rate value Q_{T} has no abnormality (Step S7).

If it is diagnosed that the first measured flow rate value Q_{T} has no abnormality, the valve diagnostic part 7 obtains the reference voltage value Vo that is to be applied to the flow rate control valve 2 during normal operation from the valve applied voltage storage part 6 on the basis of the currently measured first measured flow rate value Q_{T} and the supply pressure value Po measured by the supply pressure measuring sensor PS (Step S8). Then, the valve diagnostic part 7 compares the obtained reference voltage value Vo with the applied voltage value V currently applied to the flow rate control valve 2 (Step S9), and if the absolute value of the difference between the respective voltage values is equal to or less than the predetermined value, diagnoses that no clogging is present in the flow rate control valve 2 (Step S10). On the other hand, if the absolute value of the difference between the respective voltage values is larger than the predetermined value, the valve diagnostic part 7 diagnoses that an abnormality such as clogging occurs in the flow rate control valve 2 more than an allowable amount (Step S11).

The mass flow controller 200 and diagnostic device 200 configured as described are configured such that, first, the first measured flow rate value Q_{T} measured by the thermal type flow rate sensor 1 is compared with the second measured flow rate value Q_{P} measured by the pressure type flow rate sensor 3 to thereby diagnose whether or not the first measured flow rate value Q_{T} is correct, and only if the first measured flow rate value Q_{T} is correct, the valve diagnostic part 7 diagnoses the flow rate control valve 2, and therefore a result of the diagnosis of the flow rate control valve 2 can be made highly reliable. In other words, misdiagnosing the flow rate control valve 2 to have an abnormality when in fact there is no abnormality in the first measured flow rate value Q_{T} is avoided, and clogging or the like occurring in the flow rate control valve 2 and clogging or the like occurring in the thermal type flow rate sensor 1 can be separately diagnosed with certainty.

In variations of the mass flow controller 100 of the first embodiment, the measured flow rate value used by the stable state judging part 4 is not the first measured flow rate value Q_{T}, but may be the second measured flow rate value Q_{P}. Also, the present invention is not configured such that the valve applied voltage storage part 6 is made to preliminarily store applied voltages applied to the flow rate control valves 2 during normal operation, and the valve diagnostic part 7 refers to values of the applied voltages at the time of diagnosis, but may be configured such that, for example, on the basis of a predetermined relational expression, from the first measured flow rate value Q_{T} and the supply pressure value Pₒ, the valve diagnostic part 7 calculates an applied voltage to be applied during normal operation as the reference voltage value Vₒ, and compares it with an applied voltage currently applied, to thereby perform the diagnosis. Further, the valve diagnostic part 7 compares the voltage value currently applied to the flow rate control valve 2 with the reference voltage value that was applied during normal operation under the same conditions including the supply pressure value and the first measured flow rate value, and thereby diagnoses the flow rate control valve 2; however, the present invention may be configured to perform the diagnosis by, for example, comparing the currently measured first measured flow rate value with a first measured flow rate value that was measured during normal operation under the same conditions including the supply pressure value and the applied voltage value. Still further, the flow rate control valve may be diagnosed by comparing the current supply pressure value with a supply pressure value that was measured during normal operation under the same conditions including the applied voltage value and the first measured flow rate value. That is, the look up table may be indexed by any suitable pair of index parameters, including the applied voltage value, the first measured flow rate value, and the supply pressure value, which are used to look up the value of a parameter for the comparison. Thus, it is only necessary that the two index parameters of the table be distinct from the parameter for the comparison, to be used for a search for similar conditions.

Next, a second embodiment of the present invention is described. In addition, members common to the first embodiment are denoted by the same letters or numerals.

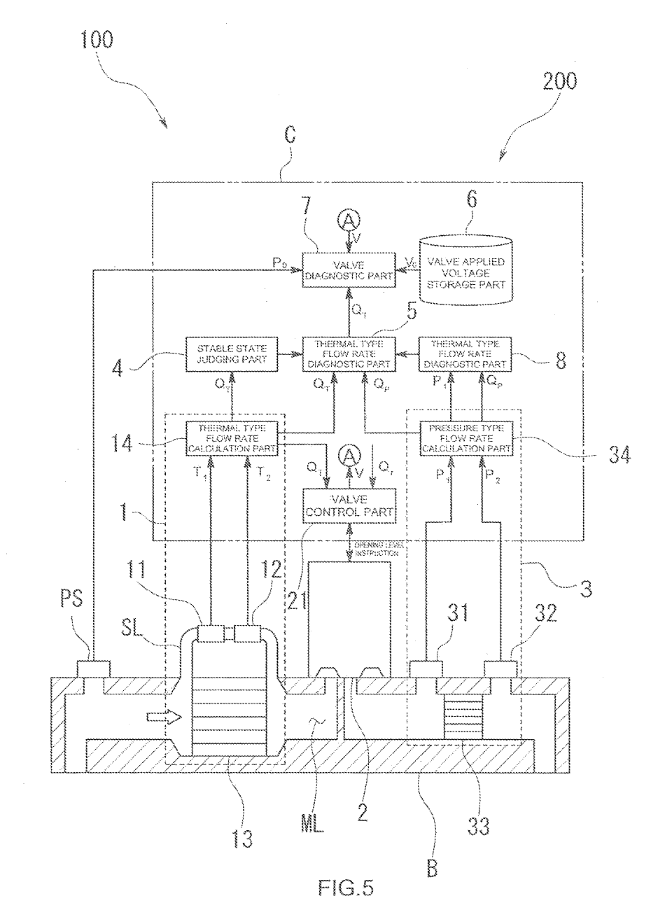

A mass flow controller 100 of the second embodiment is one that is, as illustrated in FIG. 5, in addition to the mass flow controller 100 of the first embodiment, further provided with: a supply pressure measuring sensor PS that is intended to measure a supply pressure value Pₒ of fluid, which is a pressure on an upstream side of the flow rate control valve 2; and a pressure type flow rate diagnostic part 8 that diagnoses an abnormality of a second measured flow rate value Q_{P} measured by the pressure type flow rate sensor 3. Also, the thermal type flow rate diagnostic part 5 is configured to, only if the pressure type flow rate diagnostic part 8 diagnoses that the second measured flow rate value Q_{P} has no abnormality, compare a first measured flow rate value Q_{T} with the second measured flow rate value Q_{P} to start diagnosis. Further, if the thermal type flow rate diagnostic part 5 diagnoses that the first measured flow rate value Q_{T} has no abnormality, the valve diagnostic part 7 is adapted to diagnose the flow rate control valve 2.

The respective parts are described.

The supply pressure measuring sensor PS is provided to, without externally obtaining the supply pressure value Pₒ used to diagnose the valve in the valve diagnostic part 7, enable a measurement of the supply pressure value in the mass flow controller 100.

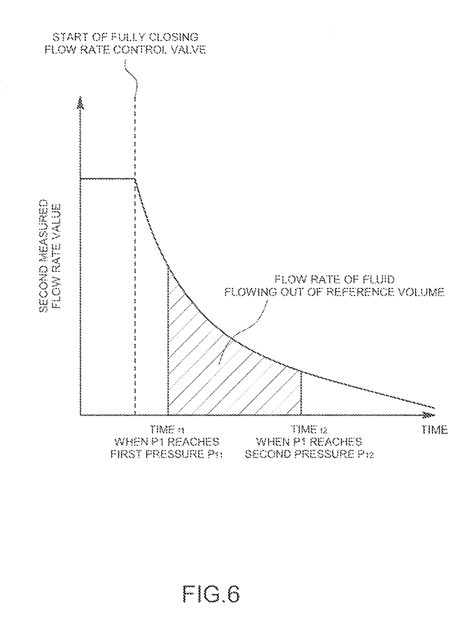

The pressure type flow rate diagnostic part 8 is one that corresponds to a second measured flow rate diagnostic part in the claims, and on the basis of a flow rate of the fluid passing through the pressure type flow rate sensor 3 within a predetermined period of time in a state where an upstream side of the pressure type flow rate sensor 3 is completely closed to eliminate the further fluid flow, diagnoses whether or not the second measured flow rate value Q_{P} has an abnormality. The pressure type flow rate diagnostic part 8 is configured to, differently from the thermal type flow rate diagnostic part 5, without requiring a measured value measured by another sensor or measuring mechanism, be able to self-diagnose only with a measured value outputted from the pressure type flow rate sensor 3 constituting the pressure type flow rate diagnostic part 8 itself. More specifically, the pressure type flow rate diagnostic part 8 is one that, as illustrated in FIG. 6, uses a reference volume from the flow rate control valve 2 to the fluid resistor 33 in the flow channel ML as a diagnostic parameter to diagnose an abnormality during a predetermined period of time from a time when a pressure measured by the first pressure sensor 31 reaches a first predetermined pressure to a time when the pressure reaches a second predetermined pressure lower than the first predetermined pressure. The pressure type flow rate diagnostic part 8 is configured to diagnose that, for example, under the condition that a diagnostic parameter that was measured during normal operation is set as a reference parameter, if a diagnostic parameter at the time of a new diagnosis and the reference parameter are different from each other, an abnormality is present. Also, the pressure type flow rate diagnostic part 8 is configured to diagnose that if a difference between the diagnostic parameter and the reference parameter is equal to or less than a predetermined value, an abnormality is not present.

In addition, the above-described reference volume can be calculated in the following manner.

That is, when setting up gas state equations with respect to the reference volume V at the time t₁ when the pressure measured by the first pressure sensor 31 reaches the first predetermined pressure P11, and at the time t₂ when the pressure reaches the second predetermined pressure P₁₂, the following expressions hold:

P₁₁V=n₁RT Expression 3

P₁₂V=n₂RT Expression 4

Herein, n₁ is a molar number of the fluid in the reference volume V at the time t₁, n₂ is a molar number of the fluid in the reference volume V at the time t₂, R is the gas constant, and T is the temperature of the fluid.

When subtracting Expression 4 from Expression 3 with respect to both sides, the following expression holds:

(P₁₁−P₁₂)V=(n₁−n₂)RT Expression 5

Here, (n₁-n₂) is a molar number of the fluid having flowed out, and therefore can be expressed as follows with use of the second measured flow rate value Q_{P} measured by the pressure type flow rate sensor:

(n₁−n₂)=(∫Q_{P}dt)/M(integration from t₁ to t₂) Expression 6

Herein, M is a molecular weight of the fluid.

Accordingly, the reference volume V can be expressed with use of the second measured flow rate value Q_{P} measured by the pressure type flow rate sensor, so that the reference volume Vₒ calculated during normal operation and the reference volume V calculated with use of the second measured flow rate value Q_{P} at the time of diagnosis are compared with each other, and if their respective values are different from each other, it can be diagnosed that the second measured flow rate value Q_{P} has an abnormality.

Furthermore, a self-diagnostic method for the second flow rate measuring mechanism is not limited to the above-described method, and various methods may be used, such as a diagnostic method that, as a diagnostic parameter, uses a period of time during which a pressure value measured by the pressure sensor changes from a certain pressure to another pressure, and a diagnostic method that is based on the fluid flowing in with a downstream side of the mass flow controller 100 being closed.

As described, the mass flow controller 100 of the second embodiment is adapted such that, first, the pressure type flow rate diagnostic part 8 diagnoses whether or not an abnormality occurs in the second measured flow rate value Q_{P} measured by the pressure type flow rate sensor 3, and then the first measured flow rate value Q_{T} is diagnosed, so that reliability of the second measured flow rate value Q_{P} as a diagnostic criterion for the first measured flow rate value Q_{T} can be enhanced, and therefore reliability of the first measured flow rate value Q_{T} can be enhanced. Accordingly, a diagnostic result of the flow rate control valve 2 diagnosed with use of the first measured flow rate value Q_{T} in the valve diagnostic part 7 can also be made highly accurate.

Variations of the second embodiment are described. For example, at the time of diagnosis by the pressure type flow rate diagnostic part 8, the diagnosis may be performed with any valve present on the upstream side of the pressure type flow rate sensor 3 being closed. Also, the diagnosis may be performed with, as a trigger, use of a pressure change occurring by closing any valve or the like present on a downstream side of the pressure type flow rate sensor 3. More specifically, the pressure type flow rate diagnostic part 8 may perform the diagnosis on the basis of an integrated value of a flow rate of the fluid passing through the pressure type flow rate sensor 3 during a period of time from a time when the pressure reaches a first pressure to a time when the pressure reaches a second pressure higher than the first pressure.

Other embodiments are described.

The flow rate control device applied with the present invention is not only a packaged one, such as the mass flow controller, but may also be one that is configured to be separately attached with respective fluid control devices. Also, to be able to add the diagnostic functions to an existing mass flow controller, a program including the stable state judging part, first measured flow rate diagnostic part, valve diagnostic part, valve applied voltage storage part, second measured flow rate diagnostic part, and the like may be installed from a recording medium or the like into a calculation part or the like. The order in which the thermal type flow rate sensor, flow rate control valve, and pressure type flow rate sensor provided in the mass flow controller are arranged from the upstream side may be any order. For example, in the case where the thermal type flow rate sensor, pressure type flow rate sensor, and flow rate control valve are arranged in this order, as a supply pressure value used to perform a diagnosis in the valve diagnostic part, a value measured by the second pressure sensor can be used. Further, the opening level control parameter used by the valve diagnostic part to diagnose the flow rate control valve is not limited to the applied voltage value described in each of the above embodiments, but may be any parameter if the parameter is judged and inputted depending on an error between a target flow rate value and a measured flow rate value in order to change an opening level of the flow rate control valve, such as an applied current value, or a pulse width of a PWM signal. In addition, the flow rate control device and diagnostic device may be configured such that, with the stable state judging part being omitted, the pressure calculation part calculates a calculated pressure value regardless of the state of the fluid, and the valve diagnostic part diagnoses an abnormality. Further, the valve diagnostic part may further use a valve downstream side pressure value, which is a pressure on a downstream side of the flow rate control valve, to perform a diagnosis. More specifically, if the valve diagnostic part is adapted to perform the diagnosis on the basis of a difference between a supply pressure value, which is a pressure on the upstream side of the flow rate control valve, and the valve downstream side pressure value, i.e., a differential pressure between before and after the flow rate control valve, the opening level control parameter, the measured flow rate value, and the like, the states of the fluid before and after the flow rate control valve, in terms of ease of flow, can be accurately added to perform the diagnosis, and therefore a valve diagnosis can also be accurately performed. In addition, the valve downstream side pressure value may be measured by a pressure sensor provided in the mass flow controller, or a value measured by a pressure sensor provided in a pipe connected on the downstream side of the mass flow controller may be used.

The first flow rate measuring mechanism and the fluid measuring mechanism (second flow rate measuring mechanism) are not limited to the thermal type flow rate sensor and the pressure type flow rate sensor exemplified in the embodiments, respectively, but for example, the first flow rate measuring mechanism may be a pressure type flow rate sensor, and the fluid measuring mechanism may be a thermal type flow rate sensor. Also, the first and second flow rate measuring mechanisms may be flow rate measuring mechanisms that measure flow rates based on the same principle.

Further, in each of the above embodiments, the fluid measuring mechanism is one that measures a flow rate, but may be one that measures a pressure, and the first measured flow rate diagnostic part may be configured to, on the basis of the measured pressure value measured by the fluid measuring mechanism, diagnose an abnormality of the first measured flow rate value.

More specifically, the fluid measuring mechanism may be one that has a configuration in which the second pressure sensor that is provided on the downstream side of the fluid resistor constituting the pressure type flow rate sensor is omitted. In other words, the fluid measuring mechanism may be configured to include a fluid resistor provided in the flow channel, and a pressure sensor provided on any one of upstream and downstream sides of the fluid resistor.

In the following, described in detail is a configuration for the first measured flow rate diagnostic part to diagnose an abnormality of a first measured flow rate value on the basis of a measured pressure value measured by the fluid measuring mechanism in the case where the fluid measuring mechanism is configured to include the pressure sensor that is provided only on one of the upstream and downstream sides of the fluid resistor.

First, described is the first measured flow rate diagnostic part configured to, on the basis of the measured pressure value measured by the fluid measuring mechanism, calculate a flow rate of the fluid separately from the first measured flow rate value, and compare the calculated flow rate value and the first measured flow rate value with each other to thereby diagnose the abnormality of the first measured flow rate value.

The first measured flow rate diagnostic part is configured to, for example, during a period of time when the first measured flow rate value is normal, calculate a pressure value on a side (the other side) where the pressure sensor is not provided, and on the basis of the measured pressure value measured by the pressure sensor and the calculated pressure value, calculate the calculated flow rate value based on the pressure.

More specifically, if the first measured flow rate value is normal, the first measured flow rate value measured by the first flow rate measuring mechanism on the basis of above-described Expression 1, and the flow rate calculated by above-described pressure-based Expression 2 are equal to each other, and therefore an unknown one of the upstream side pressure value P₁ and the downstream side pressure value P₂ can be calculated. In the following, on the assumption that the pressure value P₁ is a measured value, and the pressure value P₂ is a value not measured, the description is provided.

After the downstream side pressure value P₂ has been calculated as the calculated pressure value, the first measured flow rate diagnostic part stores the value, and by substituting the measured pressure value P₁ measured by the pressure sensor and the calculated pressure value P₂ into above-described Expression 2, the calculated flow rate value that is a pressure-based flow rate value can be successively calculated. Accordingly, in this embodiment, instead of comparing the first measured flow rate value and the second measured flow rate value with each other, the first measured flow rate diagnostic part compares the first measured flow rate value and the calculated flow rate value with each other, and if an absolute value of a difference between them is equal to or more than a predetermined value, can diagnose that an abnormality occurs in the first measured flow rate value.

Next, described is the case where the first measured flow rate diagnostic part is configured to use the measured pressure value itself measured by the pressure sensor to diagnose an abnormality of a first measured flow rate value.

The first measured flow rate diagnostic part is configured to, for example, under the condition that a flow rate is controlled to be constant by the valve control part and flow rate control valve, store as a reference pressure value a pressure value measured by the pressure sensor, which constitutes the fluid measuring mechanism, at the time when the fluid comes into a stable state, and if a difference between a measured pressure value successively measured and the reference pressure value is equal to or more than a predetermined value, diagnose that an abnormality occurs in the first measured flow rate value.

Even in the case of providing the fluid measuring mechanism and first measured flow rate diagnostic part as described above, the abnormality of the first measured flow rate value can be diagnosed without directly measuring a flow rate, and with only the measured pressure value. Also, on the basis of the first measured flow rate value, of which correctness is guaranteed, the flow rate control valve can be accurately diagnosed.

Also, in the diagnosis by the valve diagnostic part, on the basis of the first measured flow rate value, an abnormality of the flow rate control valve is diagnosed; however, any sort of value may be used if the value indicates substantially the same value as the first measured flow rate value. More specifically, in the case where it is diagnosed that the first measured flow rate value is normal, the second measured flow rate value measured by the pressure type flow rate sensor, which is the fluid measuring mechanism, or the like, indicates substantially the same value, and therefore the second measured flow rate value may be used instead. Further, even in the case of the configuration in which as described above, the fluid measuring mechanism measures a pressure, the calculated flow rate value calculated from the measured pressure value also indicates substantially the same value as the first measured flow rate value, and therefore the calculated flow rate value may be used to diagnose the flow rate control valve. In other words, the valve diagnostic part may be used to diagnose the flow rate control valve on the basis of the measured pressure value that serves as a source for the calculated flow rate value and is measured by the fluid measuring mechanism, an opening level control parameter, and a supply pressure value.

Furthermore, the various embodiments may be combined or modified without departing from the scope of the present invention.

### INDUSTRIAL APPLICABILITY

The flow rate control device of the present invention, the diagnostic device used for the flow rate control device, and the recording medium recorded with the diagnostic program are configured to, first, on the basis of the second measured flow rate value or measured pressure value, judge whether or not an abnormality occurs in the first measured flow rate value used to control the opening level of the flow rate control valve, and after it is guaranteed that the abnormality does not occur; diagnose an abnormality of the flow rate control valve, and therefore the abnormality of the flow rate control valve can be diagnosed with high reliability.

1. A flow rate control device comprising:
a first flow rate measuring mechanism configured to measure a flow rate of fluid flowing through a flow channel;
a flow rate control valve provided on the flow channel;
a valve control part configured to control an opening degree of the flow rate control valve so as to reduce an error between a target flow rate value and a first measured flow rate value measured by the first flow rate measuring mechanism;
a fluid measuring mechanism configured to measure a flow rate or a pressure of the fluid flowing through the flow channel;
a first measured flow rate diagnostic part configured to diagnose an abnormality of the first measured flow rate value, based on a second measured flow rate value or a measured pressure value measured by the fluid measuring mechanism; and
a valve diagnostic part configured to diagnose an abnormality of the flow rate control valve, based on an opening level control parameter that is inputted to the flow rate control valve by the valve control part, a supply pressure value that is a pressure measured on an upstream side of the flow rate control valve, and at least one of the first measured flow rate value, the second measured flow rate value, and the measured pressure value, when the first measured flow rate diagnostic part diagnoses that the first measured flow rate value has no abnormality.

2. The flow rate control device according to claim 1, further comprising
a stable state judging part configured to judge whether or not a state of the fluid flowing through the flow channel is in a stable state, based on the first measured flow rate value or the second measured flow rate value measured by the fluid measuring mechanism or the measured pressure value, wherein
the first measured flow rate diagnostic part is configured to diagnose the abnormality of the first measured flow rate value when the stable state judging part judges that the state of the fluid is the stable state.

3. The flow rate control device according to claim 1, wherein:
the first flow rate measuring mechanism is a thermal type flow rate sensor; and
the fluid measuring mechanism is a pressure type flow rate sensor.

4. The flow rate control device according to claim 1, wherein
the valve diagnostic part is configured to diagnose the abnormality of the flow rate control valve relative to a reference opening level control parameter that is the opening level control parameter having been inputted to the flow rate control valve by the valve control part under conditions equivalent to the first measured flow rate value and the supply pressure value that are currently measured with the opening level control parameter currently inputted to the flow rate control valve by the valve control part when the flow rate control valve is operating normally.

5. The flow rate control device according to claim 1, further comprising
a second measured flow rate diagnostic part configured to diagnose an abnormality of the second measured flow rate value measured by the fluid measuring mechanism.

6. The flow rate control device according to claim 1, further comprising:
a supply pressure measuring sensor provided on the upstream side of the flow rate control valve, and outputs the supply pressure value.

7. A diagnostic device for use in a flow rate control device comprising: a first flow rate measuring mechanism configured to measure a flow rate of fluid flowing through a flow channel; a flow rate control valve provided on the flow channel; and a valve control part configured to control an opening degree of the flow rate control valve so as to reduce an error between a target flow rate value and a first measured flow rate value measured by the first flow rate measuring mechanism, the diagnostic device comprising:
a fluid measuring mechanism configured to measure a flow rate or a pressure of the fluid flowing through the flow channel;
a first measured flow rate diagnostic part is configured to diagnose an abnormality of the first measured flow rate value, based on a second measured flow rate value or a measured pressure value measured by the fluid measuring mechanism; and
a valve diagnostic part configured to diagnose an abnormality of the flow rate control valve, based on an opening level control parameter that is inputted to the flow rate control valve by the valve control part, a supply pressure value that is a pressure measured on an upstream side of the flow rate control valve, and at least one of the first measured flow rate value, the second measured flow rate value, and the measured pressure value, when the first measured flow rate diagnostic part diagnoses that the first measured flow rate value has no abnormality.

8. A diagnostic program for use in a flow rate control device comprising: a first flow rate measuring mechanism configured to measure a flow rate of fluid flowing through a flow channel; a flow rate control valve provided on the flow channel; a valve control part configured to control an opening degree of the flow rate control valve so as to reduce an error between a target flow rate value and a first measured flow rate value measured by the first flow rate measuring mechanism; a fluid measuring mechanism configured to measure a flow rate or a pressure of the fluid flowing through the flow channel, the diagnostic program comprising:
a first measured flow rate diagnostic part is configured to diagnose an abnormality of the first measured flow rate value, based on a second measured flow rate value or a measured pressure value measured by the fluid measuring mechanism; and
a valve diagnostic part configured to diagnose an abnormality of the flow rate control valve, based on an opening level control parameter that is inputted to the flow rate control valve by the valve control part, a supply pressure value that is a pressure measured on an upstream side of the flow rate control valve, and at least one of the first measured flow rate value, the second measured flow rate value, and the measured pressure value, when the first measured flow rate diagnostic part diagnoses that the first measured flow rate value has no abnormality.
